(19) United States
(12) Patent Application Publication
(10) Pub. No.: US 2005/0211828 A1
(43) Pub. Date: Sep. 29, 2005

(54) Aerodynamic orbit inclination control

(75) Inventors: Paul Gloyer, Waveland, MS (US); Thomas W. Vanek, Gloucester, MA (US); Joel Pedlikin, Boston, MA (US)

Correspondence Address: ROBERT M. MCDERMOTT, ESQ., 1824 FEDERAL FARM ROAD, MONTROSS, VA, 22520, US

(73) Assignee: AeroAstro, Inc.

(21) Appl. No.: 11/032,706

(22) Filed: Jan. 11, 2005

Related U.S. Application Data
(60) Provisional application No. 60/551,462, filed on Mar. 9, 2004.

(51) Int. Cl. B64G 1/00

(52) U.S. Cl. 244/51

(57) ABSTRACT

A method and system for deploying a spacecraft into a target orbit includes the use of controllable aerodynamic surfaces that can be deployed to facilitate a change in the inclination angle of the trajectory of the spacecraft. In a typical embodiment, the spacecraft includes an orbit transfer vehicle containing the aerodynamic structure, and a satellite that is to be placed into the target orbit. The spacecraft is launched to a higher-energy orbit than the target orbit, and the energy released by traveling to the target orbit is used to change the inclination angle. After entering a transfer orbit that includes a passage through the upper limits of the earth's atmosphere, the orbit transfer vehicle deploys the aerodynamic structure, and controls the aerodynamic surfaces of the structure to induce lift forces that alter its inclination angle each time the vehicle enters the atmosphere.

This application claims the benefit of U.S. Provisional Patent Application 60/551,462, filed 9 Mar. 2004.

### BACKGROUND AND SUMMARY OF THE INVENTION

This invention relates to the field of aerospace, and in particular to an orbit transfer vehicle that uses aerodynamics to achieve a desired orbit inclination angle.

U.S. Pat. No. 6,286,787 “SMALL SATELLITE GEO-TO-LEO ORBIT TRANSFER VEHICLE”, issued 11 Sep. 2001 to Richard Fleeter, U.S. Pat. No. 6,409,124 “HIGH-ENERGY TO LOW-ENERGY ORBIT TRANSFER VEHICLE”, issued 25 Jun. 2002 to Richard Fleeter, and U.S. Pat. No. 6,550,720 “AEROBRAKING ORBIT TRANSFER VEHICLE”, issued 22 Apr. 2003 to Richard Fleeter, Daniel B. DeBra, Paul Gloyer, Zeno Wahl, and David Goldstein, each incorporated by reference herein, teach the placement of a satellite into target orbit by first launching the satellite into a transfer orbit having a substantially higher potential energy than the target orbit, then decreasing the energy of the satellite. In this manner, the launch vehicle provides the higher initial energy, and the satellite need only contain means for decreasing its energy to drop to a lower orbit, rather than means for providing energy to reach a higher orbit. Typically, the satellite is attached to an orbit-transfer vehicle, and the orbit-transfer vehicle uses drogues to decrease its velocity as it traverses the upper limits of the earth's atmosphere. When the target elevation is achieved, the orbit transfer vehicle maneuvers the satellite into its desired orbit.

Although a high-energy to low-energy orbit change as taught by the above inventions provides for a substantial reduction in the amount of fuel required to be carried by the satellite, or the orbit transfer vehicle, fuel is still required during the maneuvering process to change the inclination angle of the satellite's orbit, if the inclination angle provided by the launch vehicle (the insertion inclination) is different from the inclination of the target orbit.

Additionally, conventional propulsion systems are limited in their ability to effect major inclination angle changes. For example, an orbit transfer vehicle with conventional propulsion system would be required to allocate at least half its mass to achieve a twenty five degree change in inclination angles. For this reason, different launch locations are required to achieve substantially different orbit inclination angles.

It is an object of this invention to minimize the amount of fuel required to maneuver a satellite into its target orbit, and particularly the amount of fuel required to change the inclination angle of an orbiting object. It is a further object of this invention to reduce the amount of fuel that an orbit transfer vehicle needs to carry. It is a further object of this invention to provide a means for achieving changes in inclination angles of more than forty five degrees.

These objects and others are provided by a method and system that use aerodynamic forces to deploy a spacecraft into a target orbit. The spacecraft includes controllable aerodynamic surfaces that can be deployed to facilitate a change in the inclination angle of the trajectory of the spacecraft. In a typical embodiment, the spacecraft includes an orbit transfer vehicle containing the aerodynamic structure, and a satellite that is to be placed into the target orbit. The spacecraft is launched to a higher-energy orbit than the target orbit, and the energy dispelled to travel to the target orbit is used to change the inclination angle. After entering a transfer orbit that includes a passage through the upper limits of the earth's atmosphere, the orbit transfer vehicle deploys the aerodynamic structure, and controls the aerodynamic surfaces of the structure to induce lift forces that alter its inclination angle each time the vehicle enters the atmosphere.

### BRIEF DESCRIPTION OF THE DRAWINGS

The invention is explained in further detail, and by way of example, with reference to the accompanying drawings wherein:

FIG. 1 illustrates an example trajectory of an orbit transfer vehicle that includes an orbit inclination change in accordance with this invention.

FIGS. 2A-2F illustrate example aerodynamic structures that can be configured to provide lift forces that can effect an orbit inclination change in accordance with this invention.

FIGS. 3A-3B illustrate an example deployable aerodynamic structure in accordance with this invention.

FIG. 4 illustrates an example block diagram of an orbit transfer vehicle in accordance with this invention.

Throughout the drawings, the same reference numerals indicate similar or corresponding features or functions. The drawings are included for illustrative purposes and are not intended to limit the scope of the invention.

### DETAILED DESCRIPTION OF THE INVENTION

The invention is presented using the paradigm of a conventional launch of an orbit transfer vehicle into a geosynchronous orbit (GEO) and a subsequent maneuvering of the orbit transfer vehicle into a target low earth orbit (LEO) at a given inclination angle. However, one of ordinary skill in the art will recognize that the invention is not limited to this example. For example, in surveillance or other applications, the transfer vehicle may remain at a high-energy orbit indefinitely, and then employ the techniques of this invention to maneuver to a target inclination in order to overpass select regions of the earth when a need arises, and remain there until a new need arises. Each maneuver results in a lower-energy orbit, but this as-needed maneuvering can be repeated until the energy is insufficient to provide the desired amount of inclination change. Similarly, propulsion systems can be provided to offset and/or restore the loss of orbit energy. In like manner, although the invention is presented in terms of an orbit transfer vehicle and a payload satellite, one of ordinary skill in the art will recognize that the principles of this invention are not limited to this particular configuration or combination of components.

In a preferred embodiment of this invention, an orbit transfer vehicle containing a payload satellite is launched into a geosynchronous orbit (GEO) using a conventional launch vehicle, and is maneuvered into a transfer orbit (GTO) that includes passage through an upper layer of the earth's atmosphere, at about 150 km, as disclosed in the above referenced patents. For ease of reference, the term spacecraft is used hereinafter to refer to this combination of orbit transfer vehicle and satellite.

While in the transfer orbit, the spacecraft deploys an aerodynamic structure. As the spacecraft begins to enter the atmosphere it performs a roll maneuver to orient the lift vector of the aerodynamic structure in a desired orbit-normal direction. The lift created by the aerodynamic structure will generate a torque that is applied to the orbit and the orbital angular momentum vector will attempt to align with this torque vector. As the angular momentum vector swings toward the torque vector, the orbit is rotated about its line of apsides, effectively changing the orbit inclination angle.

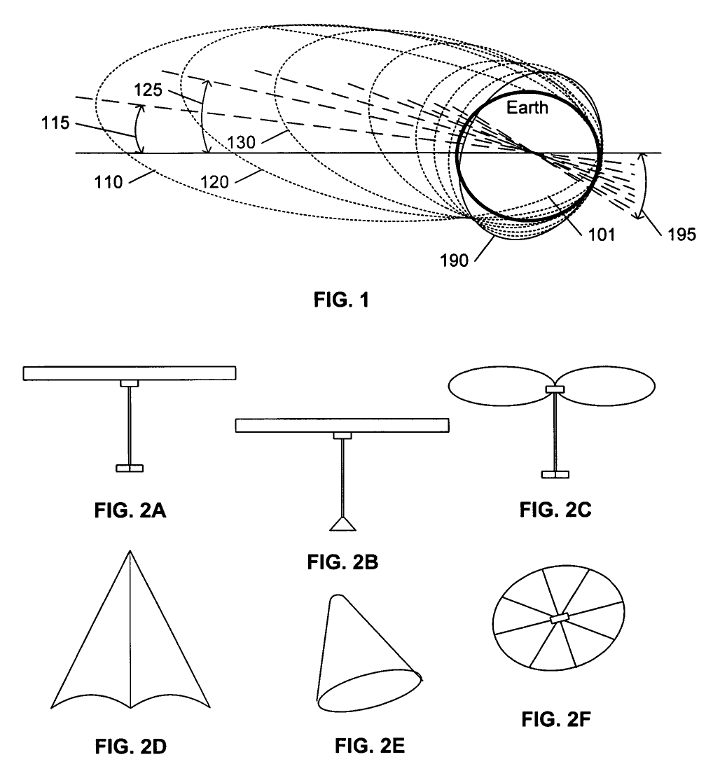

FIG. 1 illustrates the operation of this invention. A spacecraft (not shown) is launched into a high-energy orbit and enters a transfer orbit 110 that includes passage 101 sufficiently near the earth to encounter some atmospheric friction, typically below 200 km from the earth. The transfer orbit 110 has an initial inclination angle 115, relative to the equator of the earth, that is determined substantially by the location of the launch site (not shown). When the aerodynamic surface of the spacecraft is suitably controlled, the pressure of the air against the surface applies lift forces that are normal to the orbit, and the spacecraft enters a new orbit 120 that has a different inclination angle 125. FIG. 1 is not to scale, and the illustrated changes to the inclination angle are exaggerated for ease of understanding of this invention. Orbit 120 provides a subsequent pass through the atmosphere with the aerodynamic surface of the spacecraft suitably controlled, and a new orbit 130 is achieved.

Each pass through the atmosphere provides an incremental inclination change until a desired inclination angle 195 is achieved at orbit 190. During these inclination-angle-changing maneuvers, some orbital energy is lost, and the elevation of the orbit decreases. In a typical deployment of the payload to low-earth-orbit, this loss of elevation is desired. In a preferred embodiment of this invention, the aerodynamic surface of the spacecraft is also designed to provide additional energy-reducing (aerobraking) effects so that the desired elevation is achieved soon after the desired inclination angle is achieved. As detailed in the above referenced patents, when the final orbital apogee is achieved, perigee raising maneuvers are performed to circularize the orbit and the payload is deployed in this desired circular orbit at the desired inclination angle. These perigee raising maneuvers are typically performed using conventional propulsion means.

As the spacecraft passes through the atmosphere, drag is induced that reduces the spacecraft's orbital (kinetic) energy. A transfer from GTO to LEO provides over 20 MJ/kg of energy (˜2 km/s ΔV). If the aerodynamic surface of the spacecraft is designed to provide a lift-to-drag (L/D) ratio of 1, the energy available from a GTO to LEO orbit can provide up to about 18 degrees of change of inclination angle. If the aerodynamic surface of the spacecraft is designed to provide a lift-to-drag ratio of 4, up to 75 degrees of inclination angle change can be achieved. The efficiency of converting the orbital energy to inclination angle changes will be dependent upon the accuracy and precision of the control of the aerodynamic surface, and the control of the spacecraft's attitude and thrust vectors.

During the GTO to LEO transfer, some propulsion will generally be required to control perigee of the incremental orbits and to stabilize/control the spacecraft's attitude, but little or no fuel will be required to effect the desired inclination angle changes.

Preferably, the spacecraft skims the outer layer of the atmosphere, where the density is low, so that aeroheating caused by the friction of the atmosphere is below the point at which special thermal protection is required, and below the point at which precision control is required to avoid catastrophic trajectory errors. Without the need for thermal protection, ultra light structural technology can be used to produce a very mass efficient structure. In this rarified flow, a large aerodynamic surface is used to produce sufficient forces for orbital maneuvers. The aerospace structure is preferably a large and lightweight “gossamer” deployable structure. This allows the structure to produce significantly more inclination change per unit of mass than is possible with the heavy heat shielded structure of a lower-atmosphere approach. Although the principles of this invention can be applied to a heat shielded structure that dips below 100 km and achieves substantial lift forces with relatively small surfaces, the preferred low-friction maneuvering at 130-200 km substantially reduces the risk to the mission by allowing easy recovery from potential control errors and atmospheric uncertainty.

To provide the necessary energy-transfer from GTO-to-LEO within approximately 100 to 300 orbits (about 30 to 60 days), at a moderate perigee of 150 km, as taught in the above referenced patents, each kilogram of spacecraft mass requires approximately one square meter of planform area for aerobraking. If a faster transfer is desired, such as going from GTO-to-LEO in less than a week, it would be necessary to provide approximately 4 square meters of planform area per kg of spacecraft mass, and to use an aggressively low perigee of 130 km altitude.

As noted above, a GTO-to-LEO transfer using an aerodynamic surface with a lift-to-drag ratio of 1 can achieve an inclination angle change of up to 18 degrees. A high-performance Hall thruster can produce a 15 degree change in inclination angle using approximately 15% of the mass of the spacecraft. Preferably, to be competitive with conventional propulsion for providing inclination angle changes, the mass of the aerodynamic structure should be in the order of 15% of the mass of the spacecraft, assuming an L/D ratio of 1. Thus, using the above ratio of one square meter of area per spacecraft mass, an aerodynamic structure with an L/D ratio of 1 should preferably have a mass of less than 0.15 kilogram per square meter. To achieve this light weight, and to provide a compact form for launching, the aerodynamic structure is preferably fabricated using inflatable structure technology, similar to terrestrial inflatable wing technology. Similarly, elastic ribs and spars can be designed to spring into shape when released from their folded package. Conventional structures, using, for example, hollow aluminum tubes and hinges can also be used, although they will generally be heavier than the aforementioned inflatable or spring loaded sails. The conventional structures provide the advantage of being well understood and can provide a degree of stiffness that facilitates controlled lift.

It is likely that a diffuse shock will form a meter or so in front of the aerodynamic structure as it passes through the atmosphere. While this diffuse shock is expected to have little effect on the aerodynamic forces, some ionization of the flow will likely occur. The diffuse shock may also act as an atmospheric filter and capture the larger gas molecules, while allowing the smaller ones to pass. In a preferred embodiment, the materials used in the aerodynamic structure are selected based on a higher estimated percentage of atomic oxygen strikes than a free molecular flow model would indicate.

FIGS. 2A-F illustrate a variety of aerodynamic structures that can be used to provide a controllable aerodynamic surface for producing lift that induces a change in inclination orbit in accordance with this invention.

FIGS. 2A, 2B, and 2C illustrate a conventional glider shape. FIG. 2A includes a conventional cruciform tail, whereas FIG. 2B includes a less-conventional conical tail that provides excellent directional stability in a rare atmosphere. FIG. 2C illustrates a glider with elliptical wings that provide a substantially larger surface area with less of a lateral extent, thereby facilitating the use of less massive support structures. The glider of FIG. 2C may also be configured using a conical tail. In each of these examples, roll control is achieved using control surfaces on the wings, or by rotating the wing structures. The cruciform tail structure provides for enhanced attitude and/or roll control by including a control surface on the tail and/or by rotating the tail structure. Another control surface on the tail structure can also be used to control yaw, as in conventional gliders. An asymmetric conical tail may also provide for roll, attitude and/or yaw control.

FIG. 2D illustrates a “waverider” configuration that is particularly well suited for an embodiment that uses inflatable or otherwise extendable booms that stretch a membrane into shape. Attitude and roll control in this embodiment is achieved by wing warping, controllable surfaces, and/or center-of-gravity positioning, as in conventional ultralight structures, such as hang-gliders.

FIG. 2E illustrates an asymmetric cone configuration, based on a modification of an example aerobraking surface in the aforementioned U.S. Pat. No. 6,550,720. As in FIG. 2D, inflatable or otherwise extendable booms are deployed to stretch a membrane into shape. The asymmetric configuration provides for asymmetric aerodynamic forces as the cone traverses the atmosphere. Attitude and roll control is provided by orienting the cone in the appropriate direction.

FIG. 2F illustrates a flat disk configuration, based on another modification of the example aerobraking surface in U.S. Pat. No. 6,550,720, to achieve a higher L/D ratio than that of the asymmetric cone configuration of FIG. 2E. In this embodiment, attitude and roll are controlled using control surfaces at the boom tips.

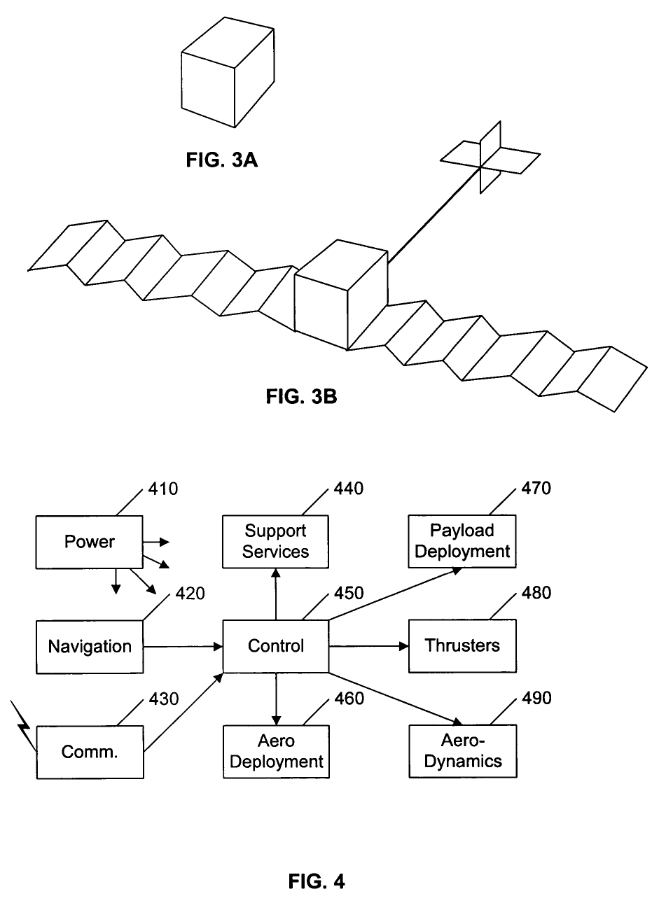

As noted above, any of a variety of techniques can be used to provide a large aerodynamic surface that is deployable from a compact spacecraft structure. FIGS. 3A and 3B illustrates an example structure that is particularly well suited for deploying a glider such as illustrated in FIGS. 2A and 2B. FIG. 3A illustrates the structure in its launchable, undeployed state, and FIG. 3B illustrates the structure in an intermediate state as the wings and tail structure are being deployed. Inflatable and/or hinged structures may be used to provide this accordion-like structure. In a hinged embodiment, the hinges may be formed using elastic bands, thereby providing a deployment force when the structure is released from its enclosure.

FIG. 4 illustrates an example block diagram of an orbit transfer vehicle in accordance with this invention. A power source 410 provides power to each of the other modules, as needed. A support services module 440 provides required services, such as heating and/or cooling, power allocation and regulation, and so on to the spacecraft, optionally including services to the payload satellite. A navigation module 420 provides navigation and spacecraft orientation information to a controller 450. Optionally, or additionally, navigation and control information may be provided from a ground control station via a communication module 430.

The controller 450 provides conventional control information to thrusters 480 that control the orientation and flight path of the spacecraft. Initially, the controller 450 controls the thrusters 480 to place the spacecraft into a transfer orbit (110 in FIG. 1). Thereafter, the controller 450 controls the aerodynamic deployment module 460 to deploy the aerodynamic structure. The controller 450 controls the spacecraft to properly orient the aerodynamic surface(s) 490 to achieve an orbit inclination change when it enters the atmosphere (101 in FIG. 1), as detailed above, either by direct manipulation of the surface(s) 490, or by use of the thrusters 480 to adjust the orientation of the entire spacecraft, or by a combination of both. After the spacecraft is maneuvered to the proper orbit inclination angle, and after the spacecraft achieves apogee at the proper altitude, the controller 450 controls the thrusters 480 to raise perigee so that the spacecraft operates beyond the effects of the earth's atmosphere. If the payload satellite is designed to operate independently, the controller 450 controls the payload deployment components 470 to effect a separation of the payload from the orbit transfer vehicle.

One of ordinary skill in the art will recognize that other components may also be included in the spacecraft, and/or a different arrangement of components or partition of functions may be used.

The foregoing merely illustrates the principles of the invention. It will thus be appreciated that those skilled in the art will be able to devise various arrangements which, although not explicitly described or shown herein, embody the principles of the invention and are thus within its spirit and scope.

For example, as noted above, propulsion can be provided to compensate for the drag induced in producing the incremental inclination angle changes, without reliance on a GTO-to-LEO transition. In this way, the efficiency of traditional methods of changing the inclination angle of a spacecraft can be substantially increased. For example, using a high performance Hall thruster (˜1300 Isp), approximately 50% of a spacecraft's mass would be needed to provide a 60 degree orbit inclination change in LEO without this invention. By providing an aerodynamic surface with a lift-to-drag ratio of 4, only 15% of the spacecraft's mass would be required to achieve a 60 degree orbit inclination change. In such an embodiment, the spacecraft is placed in a conventional LEO orbit, and then perigee is lowered to dip into the atmosphere to obtain the lift required to induce incremental inclination angle changes. Propulsion is applied to maintain apogee through each orbit, and then applied to raise perigee when the desired inclination angle is achieved.

These and other system configuration and optimization features will be evident to one of ordinary skill in the art in view of this disclosure, and are included within the scope of the following claims.

In interpreting these claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) each of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices or portions thereof may be combined together or separated into further portions unless specifically stated otherwise; and
h) no specific sequence of acts is intended to be required unless specifically indicated.

1. A spacecraft comprising:
a control system that is configured to maneuver the spacecraft from a first orbit to the target orbit, the first orbit having an associated first-orbit-energy that is substantially greater than a target-orbit-energy associated with the target orbit, and a first-orbit-angle that is different from a target-orbit-angle associated with the target orbit, and
an aerodynamic structure,
wherein
the first orbit includes a passage through a region of atmosphere, and
the control system is configured to control the aerodynamic structure so as induce a change in a path of the spacecraft from the first-orbit-angle toward the target-orbit-angle, using lift forces produced by the aerodynamic structure as the aerodynamic structure passes through the atmosphere.

2. The spacecraft of claim 1, wherein
the spacecraft is launched into a geosynchronous orbit, and
the control system is further configured to maneuver the spacecraft from the geosynchronous orbit to the first orbit.

3. The spacecraft of claim 2, wherein
the target orbit is a low earth orbit.

4. The spacecraft of claim 2, wherein
the aerodynamic structure is configured to be stored in a compact form for launch into the geosynchronous orbit, and
the control system is further configured to deploy the aerodynamic structure to provide one or more controllable aerodynamic surfaces for producing the lift forces.

5. The spacecraft of claim 4, wherein
the one or more aerodynamic surfaces correspond to wings of a glider.

6. The spacecraft of claim 4, wherein
the one or more aerodynamic surfaces include an asymmetric cone.

7. The spacecraft of claim 4, wherein
the one or more aerodynamic surfaces include a disc.

8. The spacecraft of claim 4, wherein
the aerodynamic structure includes deployable booms between which the aerodynamic surfaces are formed.

9. The spacecraft of claim 8, wherein
the deployable booms include at least one of:
inflatable members, and
elastic members.

10. The spacecraft of claim 1, wherein
the controller is configured to control perigee of the first orbit and subsequent orbits to a target perigee that is between 120 and 200 km above earth.

11. The spacecraft of claim 10, wherein
the controller is further configured to raise the target perigee above 200 km after the spacecraft has achieved the target-orbit-angle.

12. The spacecraft of claim 1, wherein
the spacecraft is an orbit transfer vehicle that includes the controller and the aerodynamic structure.

13. The spacecraft of claim 1, wherein
the spacecraft comprises:
an orbit transfer vehicle that includes the controller and the aerodynamic structure, and
a payload satellite that is configured to operate in the target orbit.

14. The spacecraft of claim 1, further including
a propulsion component.

15. The spacecraft of claim 14, wherein
the propulsion component is configured to restore some or all of the first-orbit-energy.

16. The spacecraft of claim 1, wherein
the spacecraft is configured to pass through the atmosphere multiple times before the target-orbit-angle is achieved, and
the aerodynamic structure is configured to provide an accumulation of lift forces that are sufficient to effect the change in the path of the orbit-transfer vehicle from the first-orbit-angle to the target-orbit-angle.

17. The spacecraft of claim 16, wherein
the target-orbit-angle differs from the first-orbit-angle by at least ten degrees.

18. A spacecraft comprising:
a control system that is configured to maneuver the spacecraft from a first orbit to the target orbit, the first orbit having a first-orbit-angle that is different from a target-orbit-angle associated with the target orbit, and
an aerodynamic structure,
wherein
the control system is configured to:
maneuver the spacecraft from the first orbit to a transfer orbit at the first-orbit-angle that includes a passage through a region of atmosphere, and
control the aerodynamic structure so as induce a change in a path of the spacecraft from the first-orbit-angle toward the target-orbit-angle, using lift forces produced by the aerodynamic structure as the aerodynamic structure passes through the atmosphere.

19. The spacecraft of claim 18, further including
a propulsion unit that is configured to provide energy to replace at least some energy loss due to drag induced as the aerodynamic structure passes through the atmosphere.

20. The spacecraft of claim 19, wherein
the target orbit is a low earth orbit.

21. The spacecraft of claim 19, wherein
the aerodynamic structure corresponds to wings of a glider.

22. The spacecraft of claim 19, wherein
the aerodynamic structure includes an asymmetric cone.

23. The spacecraft of claim 19, wherein
the aerodynamic structure includes deployable booms between which aerodynamic surfaces are formed.

24. The spacecraft of claim 19, wherein
the controller is configured to control perigee of the transfer orbit and subsequent orbits to a target perigee that is between 120 and 200 km above earth.

25. The spacecraft of claim 24, wherein
the controller is further configured to raise the target perigee above 200 km after the spacecraft has achieved the target-orbit-angle.

26. The spacecraft of claim 19, wherein
the spacecraft is an orbit transfer vehicle that includes the controller, the propulsion unit, and the aerodynamic structure.

27. The spacecraft of claim 19, wherein
the spacecraft comprises:
an orbit transfer vehicle that includes the controller, the propulsion unit, and the aerodynamic structure, and
a payload satellite that is configured to operate in the target orbit.

28. The spacecraft of claim 19, wherein
the spacecraft is configured to pass through the atmosphere multiple times before the target-orbit-angle is achieved, and
the aerodynamic structure is configured to provide an accumulation of lift forces that are sufficient to effect the change in the path of the orbit-transfer vehicle from the first-orbit-angle to the target-orbit-angle.

29. The spacecraft of claim 28, wherein
the target-orbit-angle differs from the first-orbit-angle by at least ten degrees.

30. A method of changing an orbit inclination angle of a spacecraft, comprising:
controlling the spacecraft so as to enter a region of atmosphere that provides an aerodynamic effect on an aerodynamic structure associated with the spacecraft, and
controlling the aerodynamic structure so as to cause the aerodynamic effect to produce lift in a desired direction that induces a change to the orbit inclination angle of the spacecraft.

31. The method of claim 30, wherein
the region of the atmosphere corresponds to a region above earth at an elevation between 100 and 200 kilometers.

32. A method of deploying a spacecraft, comprising:
launching the spacecraft into an orbit having an orbit inclination angle,
deploying an aerodynamic structure that is attached to the spacecraft,
controlling the spacecraft so as to enter a region of atmosphere that provides an aerodynamic effect on an aerodynamic structure associated with the spacecraft, and
controlling the aerodynamic structure so as to cause the aerodynamic effect to produce lift in a desired direction that induces a change to the orbit inclination angle of the spacecraft.

33. The method of claim 32, wherein
the region of the atmosphere corresponds to a region above earth at an elevation between 100 and 200 kilometers.

34. The method of claim 32, wherein
launching the spacecraft into the orbit includes launching the spacecraft into a geosynchronous transfer orbit (GTO).

35. The method of claim 34, wherein
the aerodynamic effect also induces a decrease in an elevation of the orbit of the spacecraft toward a target orbit, and
the target orbit is a low-earth orbit (LEO).
